(19) United States
(12) Patent Application Publication
(10) Pub. No.: US 2023/0263336 A1
(43) Pub. Date: Aug. 24, 2023

(54) Induction Heating Device

(71) Applicant: Christopher M. Rey, Powell, TN (US)

(72) Inventors: Christopher M. Rey, Powell, TN (US); Samantha Tai-Yang Rey, Long Island City, NY (US); Lilliana Yue-Liang Rey, Powell, TN (US)

(73) Assignee: Christopher M. Rey, Powell, TN (US)

(21) Appl. No.: 18/056,005

(22) Filed: Nov. 16, 2022

Related U.S. Application Data
(60) Provisional application No. 63/312,188, filed on Feb. 21, 2022.

(51) Int. Cl. A47J 36/04; A47J 36/02

(52) U.S. Cl. CPC A47J 36/04; A47J 36/025; H05B 6/062

(57) ABSTRACT

An induction heating vessel, including an interior wall formed of a first material, an exterior wall formed of a second material, where the second material is different from the first material, and the second material is less magnetic than the first material, and a thermally insulating barrier between the interior wall and the exterior wall.

This application claims rights and priority to U.S. provisional patent application Ser. No. 63/312,188 filed 2022 Feb. 21, the entirety of the disclosure of which is incorporated herein by reference.

### FIELD

This invention relates to the field of inductive heating. More particularly, this invention relates to non-contact inductive heating.

### INTRODUCTION

Induction heating devices are used in a wide variety of applications including, for example, beverage containers, cooking pots and pans, and containers for industrial heating of various materials.

One benefit of such induction heating devices is that the heat source, such as the induction coil, does not get hot, but instead, causes another element to get hot, such as a compatible vessel that is used in association with the induction heater. One benefit of such a system is that the opportunity for a user to get burned is reduced, because only the vessel is heating, and not the heat source. Thus, such induction heating systems are generally considered to be safer than traditional conduction, convection, or radiation heating systems.

However, induction heating systems still do create an opportunity for burning the user, in that the heating vessel gets hot.

What is needed, therefore, is a device that tends to reduce issues such as those described above, at least in part.

### SUMMARY

The above and other needs are met by an induction heating vessel, including an interior wall formed of a first material, an exterior wall formed of a second material, where the second material is different from the first material, and the second material is less magnetic than the first material, and a thermally insulating barrier between the interior wall and the exterior wall.

In various embodiments according to this aspect, the interior wall is formed of an electrically conductive non-magnetic material. In some embodiments, the interior wall is formed of at least one of aluminum, copper, silver, and alloys thereof. In some embodiments, the interior wall is formed of an electrically conductive magnetic material. In some embodiments, the interior wall is formed of at least one of iron, nickel, cobalt, magnetic steel, rare earth metal, and permanent magnet. In some embodiments the exterior wall is non-magnetic, a poor thermal conductor, and a poor electrical conductor. In some embodiments the exterior wall is formed of at least one of stainless steel. In some embodiments, the exterior wall is non-magnetic and an electrical insulator In some embodiments, the exterior wall is formed of at least one of ceramic, high temperature plastic, and glass. In some embodiments, the insulating barrier is formed of at least one of at least a partial vacuum, polystyrene, plastic, composite material, carbon fiber, and porous silica. In some embodiments, the interior wall is coated with a protective coating. In some embodiments, the interior wall is coated with at least one of zirconium oxide, aluminum oxide, yttria-stabilized zirconia, polytetrafluoroethylene, ceramic, silicone, porcelain enamel, seasoned cast iron, and a superhydrophobic material. Some embodiments include at least one of a lid, handle, and spout. Some embodiments include a temperature sensor.

### BRIEF DESCRIPTION OF THE DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 is an embodiment of an inductive heating device having a relatively high aspect ratio.

FIG. 2 is an embodiment of a controller and display for an inductive heating device.

FIG. 3 is an embodiment of a control device for an inductive heating device.

FIG. 4 is an embodiment of an inductive heating device having a relatively low aspect ratio.

### DESCRIPTION

### Definitions

The terms, acronyms, and explanations listed below are provided for convenience and are not to be taken as binding for claim construction.

| Symbol | Definition | Units (if applicable) |
|---|---|---|
| AC | Alternating Current | Root mean squared current |
| | | in Amperes (Arms) |
| Ag | Silver | |
| Al | Aluminum | |
| Al₂O₃ | Aluminum Oxide | |
| Al-Ni-Co | Permanent magnet | |
| Co | Cobalt | |
| Cu | Copper | |
| Cu-Zn | Brass | |
| Cu-Sn | Bronze | |
| Δ | Electromagnetic skin depth | Meters (m) |
| DC | Direct Current | Amperes (A) |
| Fe | Iron | |
| Y | AC excitation frequency | Hz |
| μᵣ | Relative magnetic | dimensionless quantity |
| | permeability | |
| μ₀ | Magnetic permeability of | (H/m) |
| | free space | |
| Nd-Fe-B | Permanent magnet | |
| Ni | Nickle | |
| P | Electrical resistivity | (μ-m) |
| Rₑ | Rare-earths | |
| RF | Radio-frequency | Hertz (Hz) |
| Sm-Co | | Permanent magnet |
| 300 SUS | Non-magnetic stainless | |
| | steel | |
| 400 SUS | Magnetic stainless steel | |
| ZrO | Zirconium Oxide | |

### General Overview

The present disclosure describes an apparatus or device that is used to inductively heat any fluid, a consumable beverage, related food commodity, or any other type of useful commodity using a heating element that is inductively coupled to a heat source, where the heat source is electrically powered by an Alternating Current (AC) power source.

The terms electromagnetically coupled, inductively coupled, and non-contact heating tend to be used interchangeably throughout this disclosure, and generally have the same meaning. The terms heating element, interior vessel wall, magnetic material, magnetic heating element, or high μr material, also tend to be used interchangeably throughout this disclosure, and generally have the same meaning. Similarly, the terms heat source and AC excitation magnet tend to be used interchangeably throughout this disclosure, and generally have the same meaning. Finally, the terms container, vessel, pot, pan, mug, cup, canister, tank, bin, etc. tend to be used interchangeably throughout this disclosure, and generally have the same meaning.

### Safety Features

The embodiments described in the present disclosure are superior to the prior art for many reasons including, but not limited to, their inherent safety features that the prior art does not possess. The superior safety features of these embodiments are enabled, at least in part, by a synergistic combination of multiple features including, but not limited to, at least one of (a) non-contact, inductive heating, (b) a thermally insulating vessel, (c) intelligent temperature control, (d) temperature monitoring of both the interior and exterior vessel wall, and (e) other features as described herein.

The embodiments described use a non-contact, inductive heating method to generate heat from the heating element, which is inductively coupled to the heat source/AC excitation magnet. Inductive heating is a highly energy efficient and safe method to generate heat, especially when compared to traditional direct-contact heating methods. In contrast to non-contact, electromagnetically coupled, inductive heating means of the embodiments presented herein, direct-contact heating methods include, but are not limited to, electric resistive heating elements, convective heating via hot gas transfer, combustion of fossil fuels, combustion of other flammable fuels, among other types of direct-contact heating processes. The non-contact, inductive heating methods described in this disclosure are safer than traditional direct heating means due to a synergistic combination of multiple features.

First, the inductive heating methods are non-contact electromagnetically coupled methods, meaning that the thermally insulating vessel containing the fluid, food, or other commodity does not have to be in direct physical contact with the heat source/AC excitation magnet. This avoids the potential for injury if the heat source is accidentally touched or alternatively comes into physical contact with any non-magnetic object during AC excitation. This inherent safety feature is different than direct means such as an electric resistive heating element, heated gas transfer, or open flame type heat source, which could result in potential injury or possibly even in fire ignition if unwanted contact to the heat source accidentally occurs. In the present invention described in this disclosure, only the heating element located on the interior vessel wall raises its temperature and not the heat source. In direct heating methods, both the heat source and the heating element become hot.

Second, the means for heating in the present embodiments is an AC power source, in which the frequency (υ) of the AC excitation magnet can be specifically tuned so that only a select few highly magnetic and electrically conducting materials forming the interior wall of the insulating vessel will generate heat during AC excitation from the heat source. Although it is theoretically possible to inductively heat nearly any electrically conducting material (e.g., Al, Ag, Cu, Cu—Zn, Cu—Sn, stainless steel (SUS), etc.), it is often easier and far less expensive to only heat electrically conducting materials that also have a high relative magnetic permeability (μᵣ).

As the term is used herein, materials that are considered non-magnetic have a μr of about one. As used herein, materials that are considered relatively highly magnetic have a that is greater than about ten.

Examples of materials that are both electrically conducting and have high μᵣ include but are not limited to: Fe, Ni, Co, Fe₃O₄, magnetic steel, 400 series stainless steel, Sm—Co, Nd—Fe—B, Al—Ni—Co, Rare Earths (Rₑ), and alloys thereof, among other types of high μᵣ materials. By purposely selecting to inductively heat only electrically conducting materials that also have a high μᵣ, other common non-electrically conducting materials (e.g., skin, flesh, cloth, paper, wood, plastics, etc.) as well as low μᵣ, electrically conducting materials (e.g., Al, Ag, Cu, Cu—Zn, Cu—Sn, 300 series SUS, etc.) are not heated unintentionally. This greatly limits the number of injuries and heating accidents by limiting the types of materials that can be inductively heated to only a select few substances. The embodiments described in this disclosure only inductively heat certain selected magnetic materials (steel, 400 series SUS, etc.), which are strategically located at specific parts of the thermally insulating vessel.

Third, the thermally insulating vessel described in this disclosure is designed such that only the interior wall of the vessel is formed of an electrically conducting and magnetic material, while the exterior wall of the vessel is purposely not. Therefore, only the interior wall of the vessel, or a select portion of the interior wall, will act as the heating element. Since only the interior wall of the vessel is inductively coupled to the heat source, only the interior wall of the insulating vessel will heat during AC excitation from the power source and the exterior wall will not. In the embodiments described in this disclosure, the exterior wall is thermally insulated from the interior wall (i.e., heating element), this will create a temperature gradient between the two walls. The resulting benefit is that the exterior vessel wall is cooler than the warmer interior vessel wall.

In one embodiment, the heat source is inductively coupled to the interior wall of a thermally insulating vessel, and the two are not in direct physical contact with each other. In this manner, not only is the heat generation isolated to a select few materials possessing both high μᵣ and electrically conducting, but the heated surface, which is located on the interior wall of the vessel and in intimate thermal contact with the vessel contents, is thermally isolated from the exterior of the vessel. By thermally isolating the heated surface from the exterior wall of the vessel via a thermally insulating barrier, injury and other damage can be mitigated if a person or object comes into contact with the exterior wall of the vessel.

In another embodiment, a so-called intelligent or smart feature is included. This feature includes at least one or more temperature controls that once activated, turns-off, turns-on, or modulates the power flow coming from the AC power source to the heat source. This manages the temperature that the heating element (and, thereby, the vessel contents that are in intimate thermal contact with the heating element) can achieve. The temperature control can either be passive (e.g., thermally activated bi-metallic strip, etc.) or active. Active control is one in which a direct temperature measurement of the heating element or vessel contents is performed, and the controller subsequently sends a signal to shut-off or reduce the power from the AC power source to the heat source. The terms intelligent control and smart control tend to be used interchangeably throughout this disclosure, and generally have the same meaning.

### Mobile or Transportable Platforms

The embodiments described in the present disclosure are particularly beneficial when used on mobile platforms, due to their inherent safety features. Various types of mobile platforms that such embodiments could be used on include, but are not limited to, automobiles, trucks, buses, airplanes, trains, ships, spacecraft, and other types of mobile platforms.

### Inductive Heating

In some embodiments, the heat source is formed of at least one AC excitation magnet. As used herein, the terms “AC power source,” “heat source,” and “heating element” have generally different meanings. The AC power source is the AC power flowing from the electricity generation source (i.e., typically a wall outlet) to the AC excitation magnet. The term “heat source” refers to the AC excitation magnet itself, and the term “heating element” refers to the electrically conducing and high μr material that is strategically located on the interior wall of the vessel. The term “heating element” refers to the material that is electromagnetically coupled to the heat source. It will be understood by one of ordinary skill in the art that when the heat source and the heating element are inductively coupled, they may or may not be in direct physical contact with each other.

The vessel contents are placed in direct contact with the heating element of the vessel. Thus, through AC excitation of the heat source, the inductively coupled heating element is heated. Since the contents to be heated are in direct thermal contact with the heating element, the contents are simultaneously heated.

### Induction Heating

Without being bound by theory, a discussion of the mechanism of inductive heating is next provided.

By applying an alternating current (AC) from the power source to the induction magnet (i.e., heat source), eddy currents or induced currents, begin to flow of the surface of the electrically conducting element causing it to generate heat. The required AC excitation frequency of the induction magnet depends, at least in part, on the electromagnetic skin depth (δ) of the metallic heating element given by equation 1, below:

δ=(ρ/μᵣμₒ*π*υ)^{1/2} [1]

where μᵣ is the dimensionless relative magnetic permeability of the material, μ₀ is the magnetic permeability of free space equal to 4π×10⁻⁷ H/m, ρ is its electrical resistivity in Ω-m, and υ is the AC excitation frequency in Hz. For most electrically conducting metals (e.g., Cu, Al, Ag, Au, etc.), μᵣ˜1 and ρ varies roughly between 1-100 μΩ-cm at room temperature. However, for a certain class of materials know as ferromagnetic or ferrimagnetic materials, μᵣ can be quite large often varying between 10→>10,000. When an electrically conducting material with a high μᵣ is used for the interior wall (or a portion of the interior wall) of the insulated vessel, the skin depth increases and hence the required AC excitation frequency can be substantially lowered to the kHz range.

Thus, the use of high μᵣ electrically conducing materials for the heated surface, greatly facilitates the inductive heating process and substantially lower the fabrication cost of the heat source (i.e., AC excitation magnet). Non-magnetic, but electrically conducting metals (Cu, Al, Ag, SUS, etc.) could also be used for the interior wall of the insulated vessel. However, since their μᵣ˜1, higher AC excitation frequencies are needed to generate equivalent heat. Higher AC excitation frequencies typically leads to higher cost induction magnets. For electrically conducting materials with low μᵣ˜1, the required AC excitation frequency increase significantly to the RF band in the MHz→GHz range. In addition, as mentioned previously, limiting the interior vessel wall to a select few materials that are both electrically conducting and have high μr (e.g. magnetic steel, 400 series SUS, etc.) reduces the potential for accidental heating or unwanted ignition of objects other than the interior vessel wall.

### Thermally Insulating Vessel

A component of the embodiments described in this disclosure is the thermally insulating vessel. The thermally insulating vessel described in some embodiments is formed of at least three sections: 1) an interior wall, 2) an exterior wall, and 3) a thermally insulating barrier located between the interior and exterior wall. The interior wall of the vessel (i.e., heating element) is inductively coupled to the heat source (i.e., AC excitation magnet). The top surface of the interior vessel wall is where the contents (fluid, food, or other commodity) are placed; thus, when the interior vessel wall is inductively heated via the heat source, the contents are simultaneously heated, since they are in direct contact with the proximate surface of the interior vessel wall. The exterior wall of the vessel is thermally isolated from the interior wall via a thermally insulating barrier and, as such, will be at a substantially cooler temperature.

In one embodiment, the interior vessel wall is formed of a single, uniform, homogenous high uᵣ, electrically conducting material such as magnetic steel or 400 series SUS. In this embodiment, the interior vessel wall and the heating element are one and the same.

In another embodiment, the interior vessel wall is formed of at least two materials. One material is a high μᵣ, electrically conducting material such as magnetic steel, 400 series SUS, or a permanent magnet (Nd—Fe—B, Sm—Co, Al—Ni—Co, etc.). The magnetic material, in some embodiments, is dispersed within a low μᵣ, high thermal conducting material such as at least one of Cu, Al, and alloys thereof. In this embodiment, the magnetic material dispersed throughout the high thermal conducting material forms the heating element. Thus, when the uniformly dispersed magnetic material (i.e., heating element) is inductively heated by the heat source, the highly thermal conducting material conducts the heat to evenly spread out the heat over the surface of the interior wall of the vessel.

In some embodiments described in this disclosure, the exterior wall of the vessel is mechanically attached or mechanically coupled to the interior vessel wall; however, the exterior vessel wall is also thermally isolated from the interior wall by a thermally insulating barrier. The exterior vessel wall is formed of low μᵣ, low thermal conducting material that does not inductively heat under AC excitation from the heat source. When the interior vessel wall is subjected to an AC induction field, eddy currents begin to flow which causes the interior vessel wall to heat. Since the exterior vessel wall is not magnetic and is separated by a thermally insulating barrier, a temperature gradient (ΔT/ΔX) develops between the interior and exterior wall, where ΔT=Tₑₓₜₑᵣᵢₒᵣ−Tᵢₙₜₑᵣᵢₒᵣ and ΔX is the distance separating the interior and exterior vessel wall.

The exterior vessel wall can be formed of many types of materials including, but not limited to, low μᵣ, low thermal conductivity metals such as 300 series SUS, ceramics (MACOR®, etc.), glasses, composites, and high temperature plastics (e.g., VESPEL®, TORLON®, MELDIN®, etc.). The thermally insulating barrier between the interior and exterior vessel wall could be achieved in many ways including, but not limited to, at least one of vacuum (including partial vacuum), polystyrene, plastics, composites, carbon-carbon fiber, porous silica, and other thermally insulating materials. A particularly useful thermally insulating barrier is the silica (e.g., space shuttle tile), because of its light weight, low thermal conductivity, and low cost.

For brevity, only cylindrically shaped thermally insulating vessels are described in the disclosure. However, it is understood that other types of non-cylindrically shaped vessels (e.g., square, rectangular, spherical, hexagonal, irregular, etc.) are possible. A particular useful vessel embodiment is a high aspect ratio, cylindrically shaped vessel that is adapted to contain beverages. Another particularly useful vessel embodiment is that of a low aspect ratio, cylindrically shaped vessel such as a pot, pan, or frying pan. The aspect ratio of a cylindrically shaped vessel is defined as the vessel's height (H) divided by its diameter (D). The invention described in this disclosure is useful for any aspect ratio cylindrical or non-cylindrical container, and the cylindrical shape depicted in the figures is not meant to limit the embodiments.

In some embodiments, where the interior wall is formed of a low μr and high thermal conducting material (e.g., Cu, Al, alloys thereof) and a high μᵣ magnetic material (Fe, Ni, alloys thereof), the low thermal conducting exterior vessel wall (e.g., 300 series SUS, ceramic, plastic, composite, etc.) limits the conductive heat transfer along the axial direction to its exterior surface. The thermally insulating barrier reduces the radial heat transfer between the interior and exterior walls of the vessel. The interior and exterior wall of the vessel are mechanically attached at or near the top of the vessel. There are many methods that could be used to attach or mechanically couple the exterior vessel wall to the interior vessel wall depending upon the type of materials used for the interior and exterior vessel walls. Some methods of attaching the interior and exterior vessel walls include, but are not limited to, at least one of welding, soldering, brazing, thermal shrink fit, adhesive, epoxy, bolted, threaded, rivets, and combinations thereof.

To protect the top (proximate to contents) surface of the interior vessel wall or to add a non-stick coating to the surface, at least one protective layer can be formed to increase surface durability and prolong the life of the product. There are many types of protective coatings that can be applied to the proximate surface of the interior vessel wall, depending at least in part upon the material that is used for the interior vessel wall. Some possible protective coatings include, but are not limited to, at least one of ZrO, Al₂O₃, yttria-stabilized zirconia, polytetrafluoroethylene, ceramics, silicone, porcelain enamel, seasoned cast iron, and super-hydrophobic coatings.

### Thermally Insulating Intelligent Vessel

In another embodiment, the thermally insulating vessel is an intelligent or smart vessel, as introduced above. An intelligent or smart vessel is one that contains at least one temperature sensor, at least one thermally activated control, or a combination of both sensors and controls, along with a program logic circuit (PLC) or manager. In this embodiment, once at least one of the heat source (AC excitation magnet) and the heating element (i.e., interior vessel wall) has reached a desired temperature, as measured by the embedded sensor, for a certain period of time, the electrical power to the AC excitation magnet is either reduced or turned-off so as to limit any further increase in temperature.

The intelligent vessel's thermally activated control could include at least one of a passive control and an active control. An example of a passive thermally activated control is a bi-metallic strip that opens and closes depending upon its temperature. One example of an active control is when at least one of the temperature sensors located within the intelligent vessel is measured and, based upon its temperature value, a signal is sent to the PLC to either open the circuit, thereby shutting off the AC power to the heat source, or to close, thereby allowing AC power to flow to the heat source. In another embodiment the PLC reduces the power that is allowed to flow to the heat source, thereby causing either a reduction in the temperature or maintenance at a given temperature. Thus, yet another unique feature of the invention described in this disclosure is that both the temperature of the heating element and the duration of time that the heating source is energized may be pre-set by the operator via the PLC.

### Wireless Control

In yet another embodiment, the thermally insulating intelligent vessel is remotely controlled via a wireless connection. In this embodiment, the thermally insulating intelligent vessel is externally controlled via a remote wireless application, such as could be located on a mobile device including, but not limited to, a cellular phone, computer, watch, electronic pad, or other type of mobile electronic device. Using an application protocol (aka “APP”) on the mobile device, the parameters controlling the AC excitation magnet can be managed. Once a desired temperature has been reached on at least one of the magnetic heating element or the heat source, as measured by the embedded temperature sensors contained within the thermally insulating vessel, a signal is sent to the power source to reduce and turn-off the power to the AC excitation magnet, thereby limiting the temperature of the contents disposed proximate the interior surface wall of the intelligent vessel. As an additional safety feature for the operator, a temperature measurement of the exterior vessel wall is also made in some embodiments, to ensure that the exterior vessel wall is below a desired threshold that is determined to be safe for handling. At least one of an alarm, light signal, or digital message display is added in some embodiments, to indicate when the exterior vessel wall's temperature is safe to handle, even when the interior vessel wall is not.

The wireless communication technology that is implemented to communicate with and thereby control the intelligent vessel includes, in some embodiments, the so-called Bluetooth protocol. As used herein, Bluetooth is a short-range wireless technology standard that is used for exchanging data between fixed and mobile devices over short distances using UHF radio waves from 2.4 GHz to 2.48 GHz. In the most widely used mode, transmission power is limited to ˜2.5 mW and has a relatively short range of about 10 meters. Other possible wireless communication technologies that are be used in other embodiments include, but are not limited to, WIFI and RFID, among other types of wireless communication. RFID is particularly useful in providing other types of helpful information for the user including, but not limited to, interior and exterior vessel wall temperature, heating time, user identification, stock images, personalized photographs, warning lights, alarms, or digital message displays for the user. This information is displayed, in some embodiments, on a screen that is embedded at a convenient location on the intelligent vessel. The use of other types of wireless communication technologies is also comprehended.

### Additional Embodiments

There are many practical features that are added to additional embodiments of the thermally insulating vessel. One embodiment includes a lid for covering the contents. The lid has many useful functions including, but not limited to, reducing unwanted heat transfer from the contents and thereby slowing the rate of cooling of the contents, preventing contamination from unwanted items entering the vessel, and preventing spills of the vessel's contents, such as during transport and other functions. The vessel's lid can either be thermally insulating or not thermally insulating, depending upon the application. The vessel's lid may also have at least one hole, such as for venting the contents, which can help prevent boil overs of the contents.

Other embodiments include, but are not limited to, at least one handle for grasping, at least one spout or lip for facilitating fluid pouring, mechanical features such as at least one holes or hook for hanging and storage, among other useful features. It is understood that the addition of other useful features to the thermally insulating vessel are comprehended.

In one embodiment of the invention, the handle of the intelligent thermally insulating vessel contains a display, e.g. LED, showing, for example, at least one of the temperatures of the interior and exterior vessel walls, the heating time, a user identification, and so forth.

### Depicted Embodiments

With reference now to the drawings, there are depicted all of the claimed elements of the various embodiments, although all claimed embodiments might not be depicted in a single drawing. Thus, it is appreciated that not all embodiments include all of the elements as depicted, and that some embodiments include different combinations of the depicted elements. It is further appreciated that the various elements can all have many different configurations, and are not limited to just the configuration of a given element as depicted. As indicated above, the elements of the drawings as depicted are not to scale, even with respect one to another, and relative size or thickness of one element cannot be determined by reference to any dimension of another element.

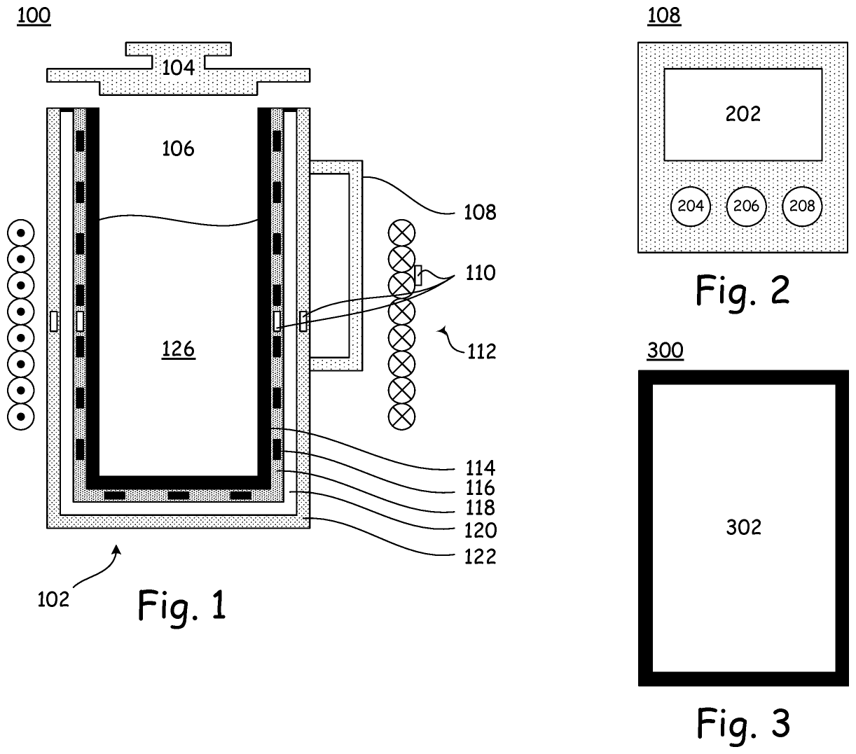

FIG. 1 depicts an embodiment 100, including a vessel 102 and a heat source 112, which as described above, is an AC excitation magnet. The vessel 102 defines an interior space 106, into which contents 126 are placed. The contents 126 are, in various embodiments, a liquid, a solid, or various combinations of the two.

The vessel 102 includes a handle 108, in some embodiments, which makes holding the vessel 102 easier and, which may, in some embodiments, provide additional thermal insulation between a user of the vessel 102 and the contents 126. Some embodiments also include a lid 104, such as might aid in the entrapment of thermal energy in the interior space 106 and the contents 126, or help prevent spilling of the contents 126. The lid 104, in various embodiments, can be detachable, selectively attachable, or retained to the other structure of the vessel 102.

The vessel 102 is formed of four basic layers, which are the outer wall 122, the inner wall 118, a thermal insulation barrier 120 and, in some embodiments, a protective coating 114 on the inner-most surface of the inner wall 118.

In some embodiments, the outer wall 122 is formed of one or more materials, as described more particularly elsewhere herein, that do not inductively couple with the AC excitation magnet 112, and thus does not heat when the AC excitation magnet 112 is energized.

In some embodiments, the inner wall 118 is formed of one or more materials, as described more particularly elsewhere herein, that do inductively couple with the AC excitation magnet 112, and thus do heat when the AC excitation magnet 112 is energized. In some embodiments, the inner wall 118 is completely formed of one or more such inductively coupling material, and in other embodiments, the inner wall 118 includes portions 116 of one or more such inductively coupling materials, interspersed in a non-inductively coupling material.

In some embodiments, a thermal insulation barrier 120 is disposed between the inner wall 118 and the outer wall 122, and is formed of one or more materials, as described more particularly elsewhere herein, that at least partially inhibit the transfer of heat from the inner wall 118 to the outer wall 122.

Some embodiments include a protective layer 114 that is disposed on the inner-most surface of the inner wall 118, adjacent the interior space 106, which protective layer 114 is formed of one or more materials, as described more particularly elsewhere herein, that protects, at least in part, at least one of the physical, chemical, and electrical properties of the inner wall 118 from the contents 126, or makes the contents 126 easier to remove from the vessel 102, or protects the contents 126 from contamination from the interior wall 118.

In some embodiments, sensors 110 are provided in various positions within the vessel 102, such as in one or more positions in at least one of the outer wall 122 and the inner wall 118, or in the heat source 112. In some embodiments, the sensors 110 sense temperature. In some embodiments, the temperature or other sensed condition is relayed by the sensors 110 to at least one of a controller or display 202.

FIG. 2 depicts such a controller, which in the embodiment depicted is disposed in the handle 108 of the vessel 102. In other embodiments, the controller and display 202 are disposed elsewhere, such as in a housing for the heat source 112, or in a device such as a smartphone 300, with display 302. In various embodiments, controls for the operation of the system 100 are provided by interface 204, 206, and 208, or by the display 302 of the smartphone 300.

In some embodiments, the controller 202 is used to set a temperature for at least one of the heat source 112, outer wall 122, and inner wall 118. The sensors 110 report the temperature of at least one of these elements, and the controller 202 adjusts the power to the heat source 112 so as to maintain and not significantly exceed the setting for the temperature. The display 202 is used, in some embodiments, to display the current temperature or the set point temperature. The controls 204, 206, and 208 are used, in some embodiments, switch the temperature as displayed from one of those values to another, and to set the desired temperature.

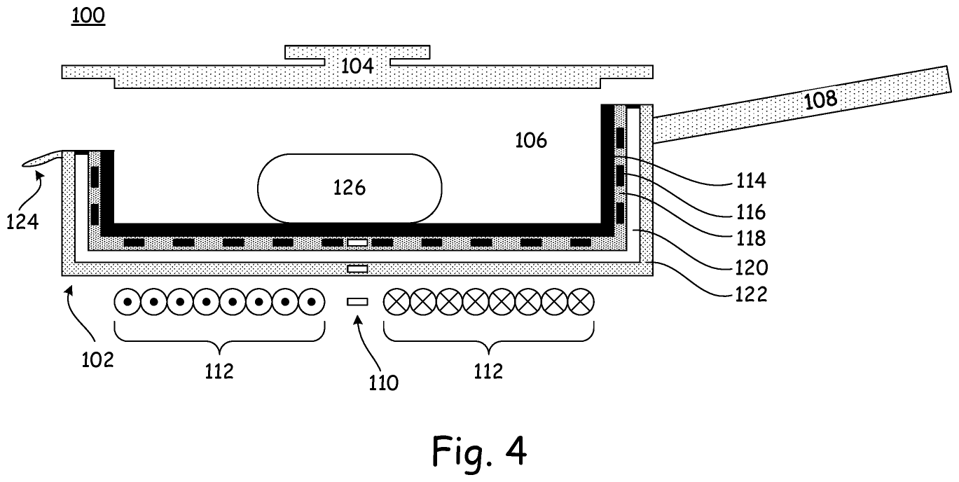

FIG. 4 depicts a relatively low aspect ratio of the vessel 102. In this embodiment a lip 124 is depicted, which lip 124 can aid in pouring or otherwise removing the contents 126 from the interior 106 of the vessel 102. It is appreciated that such a lip 124 can be incorporated into any of the various embodiments as described herein.

As used herein, the phrase “at least one of A, B, and C” means all possible combinations of none or multiple instances of each of A, B, and C, but at least one A, or one B, or one C. For example, and without limitation: Ax1, Ax2+Bx1, Cx2, Ax1+Bx1+Cx1, Ax7+Bx12+Cx113. It does not mean Ax0+Bx0+Cx0.

The foregoing description of embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. An induction heating vessel, comprising:
an interior wall formed of a first material,
an exterior wall formed of a second material, where the second material is different from the first material, and the second material is less magnetic than the first material, and
a thermally insulating barrier between the interior wall and the exterior wall.

2. The induction heating vessel of claim 1, wherein the interior wall is formed of an electrically conductive non-magnetic material.

3. The induction heating vessel of claim 1, wherein the interior wall is formed of at least one of aluminum, copper, silver, and alloys thereof.

4. The induction heating vessel of claim 1, wherein the interior wall is formed of an electrically conductive highly magnetic material.

5. The induction heating vessel of claim 1, wherein the interior wall is formed of at least one of iron, nickel, cobalt, magnetic steel, rare earth metal, and permanent magnet.

6. The induction heating vessel of claim 1, wherein the interior wall is formed of an electrically conductive highly magnetic material and the exterior wall is formed of an electrically conductive non-magnetic material.

7. The induction heating vessel of claim 1, wherein the exterior wall is formed of at least one of aluminum, copper, silver, and non-magnetic stainless steel and the interior wall is formed of at least one of iron, nickel, cobalt, magnetic steel, rare earth metal, and permanent magnet.

8. The induction heating vessel of claim 1, wherein the insulating barrier is formed of at least one of at least a partial vacuum, polystyrene, plastic, composite material, carbon fiber, and porous silica.

9. The induction heating vessel of claim 1, wherein the interior wall is coated with a protective coating.

10. The induction heating vessel of claim 1, wherein the interior wall is coated with at least one of zirconium oxide, aluminum oxide, yttria-stabilized zirconia, polytetrafluoroethylene, ceramic, silicone, porcelain enamel, seasoned cast iron, and a superhydrophobic material.

11. The induction heating vessel of claim 1, further comprising at least one of a lid handle, and spout.

12. The induction heating vessel of claim 1, further comprising a temperature sensor.

13. An induction heating vessel, comprising:
an exterior wall formed of at least one of non-magnetic stainless steel, ceramic, composites, high temperature plastic, and glass
an interior wall formed of at least one of iron, nickel, cobalt, magnetic steel, rare earth metal, and permanent magnet, and
a thermally insulating barrier between the interior wall and the exterior wall, formed of at least one of at least a partial vacuum, polystyrene, plastic, composite material, carbon fiber, and porous silica.

14. The induction heating vessel of claim 13, wherein the interior wall is coated with a protective coating.

15. The induction heating vessel of claim 13, wherein the interior wall is coated with at least one of zirconium oxide, aluminum oxide, yttria-stabilized zirconia, polytetrafluoroethylene, ceramic, silicone, porcelain enamel, seasoned cast iron, and a superhydrophobic material.

16. The induction heating vessel of claim 13, further comprising at least one of a lid handle, and spout.

17. The induction heating vessel of claim 13, further comprising a temperature sensor.

18. An induction heating system, comprising:
the induction heating vessel of claim 1, and
an induction heater.

19. An induction heating system, comprising:
the induction heating vessel of claim 13, and
an induction heater.

20. An induction heating system, comprising:
the induction heating vessel of claim 17, and
an induction heater having a switch in signal communication with the temperature sensor, for adjusting an output of the induction heater.
